(19) United States
(12) Patent Application Publication
(10) Pub. No.: US 2016/0036062 A1
(43) Pub. Date: Feb. 4, 2016

(54) CERAMIC CATHODE MATERIAL AND PREPARATION METHOD OF THE SAME

(71) Applicant: National Taipei University of Technology, Taipei City (TW)

(72) Inventors: Sea-Fue WANG, Taipei City (TW); Yung-Fu HSU, Taipei City (TW); Yi-Xin LIU, Taipei City (TW)

(21) Appl. No.: 14/445,818

(22) Filed: Jul. 29, 2014

(51) Int. Cl. H01M 4/90; H01M 4/88

(52) U.S. Cl. CPC H01M 4/9033; H01M 4/8875; H01M 4/8885; H01M 2004/8689

(57) ABSTRACT

A ceramic cathode material used in a fuel cell and a preparation method for the same are disclosed. The disclosed ceramic cathode material is prepared by a mix of lanthanum-based compound, cobalt-based compound, and copper-based compound in order to be used in intermediate/low temperature fuel cell. The ceramic cathode material may be represented in LaCo_{y}CuₓO_{3-δ} with x ranging from 0.01 to 0.3 and y ranging from 0.7 to 0.99. The prepared ceramic cathode material may be associated with high electrical conductivity and reduced coefficient of thermal expansion when operating in the temperature range between 500 and 800 degrees Celsius.

### BACKGROUND

1. Technical Field

The present disclosure relates to a ceramic cathode material used in a fuel cell and its preparation method, in particular, to a ceramic cathode material with higher electrical conductivity and lowered thermal expansion coefficient used in a fuel cell operating in a temperature range between 500 to 800 degrees Celsius.

2. Description of Related Art

A wide variety of multiple fuel cells have been in the market and generally categorized in terms of electrolyte and operating temperature. Proton exchange membrane fuel cells (PEMFC) and solid oxide fuel cells (SOFC) are among the fuel cells with largest development potential at this point.

One major reason for SOFC to gain its popularity is the capability of SOFC to be operating in reduced operating temperatures. Typical high-temperature SOFC operates in the range between 800 to 1000 degrees Celsius. However, in order to operate at such high operating temperature open-circuit voltages of the high-temperature SOFC may become lowered and the demand for the cell material may not be easily met. Besides, in such SOFC more expensive ceramic materials may become necessary to serve as connection plates, while it takes much longer for the high-temperature SOFC to heat up and cool down, which leads to tensile stress and compressive stress upon internal structure of the fuel cell causing battery components to be more vulnerable to damages. Though intermediate temperature (IT)-SOFC that operates in the range of 500-800 degrees Celsius could extend the battery life and be of no need to use the ceramic material for the connection plate (rather, other alternatives such as stainless material could be employed), electrical conductivity may decrease and active polarity may increase as the result. Thus, any material that could be used in such SOFC without sacrificing the electrical conductivity is quite critical.

SOFC could be having the following advantages: (1) better energy conversion efficiency (since conventional power generation process must go through a series of energy conversion, each of which is associated with partial energy dissipating to the air in terms of heat, and therefore its energy conversion efficiency (for example, the energy generation efficiency for coal burning is 30%) remains desired; on the other hand, the fuel cells convert the chemical energy directly to the electrical energy without burning, which undoubtedly would result in less energy loss, as evidenced by its theoretical conversion efficiency ranging from 85 to 90% despite the actual number generally stands in the range between 40 to 60%; (2) virtually noise-less: typical power generations like coal burning, hydropower, or nuclear power require large turbines and inevitably generate high volume of noises in the process; unlike the traditional approaches the fuel cell when performing electrochemical reactions does not involve mechanical parts, rendering possible the noise-less power generation; (3) less pollution: harmful substances may accompany the power generation from the coal burning, the fossil fuel, and nuclear power to pollute the environment; on the other hand, since the fuel cell requires no burning the power generation associated with the fuel cell could be free of pollutants (in the case of using hydrogen as fuel water as the end product may be generated) and should be an environmentally-friendly option; and (4) diversified fuel selection: specific fuel cells may use fuels other than hydrogen such as alcohol liquid fossil fuel because hydrogen, which is low in density, may not be properly stored to be more convenient and durable.

As the electrical conductivity, thermal expansion, and stability of the high-temperature SOFC are not satisfactory, the commercialization of the same does not pace as previously expected. In the IT-SOFC context, all perovskite, cubic fluorite and pyrochlore-based structure could meet the requirements of higher electrical conductivity, good matching with the electrolyte and stability, with perovskite leading the way.

The following includes conditions to be satisfied by any cathode material used in IT-SOFC: (1) stability: the cathode material is expected to be stable in chemistry, crystal type, morphology and dimension from the room temperature to the operating temperature while other components such as electrolyte and connection material are expected to be chemically stable; (2) electrical conductivity: the cathode is expected to have a high ionic conductivity and electronic conductivity to reduce Ohmic polarization; (3) thermal expansion: matching thermal expansion of other components such as the electrolyte and the connection material to avoid deformation, detachment, and/or fractures; (4) porosity: for the gas to penetrate into the electrode the cathode material is expected to be associated with 30% porosity; and (5) Catalytic-ability: catalytic for the oxygen to facilitate the dissociation of oxygen molecules.

Precious metals such as platinum, palladium, or silver were ever be used as the cathode material because of their high electrical conductivity. Since they are expensive and silver could be volatile at high temperatures, the perovskite-based structure having Ln₁₋ₓAₓMO_{3+δ} (Ln is lanthanide, A is an alkaline earth element, and M is a transition metal element) has been much more widely used to meet the requirements of a conductive cathode material. Usually, the alkaline earth element is added into Ln MO₃ to improve the electrical conductivity of the cathode material at the high operating temperatures. Specifically, electrical charge insufficiency caused by rare earth elements may be partially compensated by the alkaline earth elements to prompt changes in valence of the transition metal element, or on some specific occasions to form oxygen vacancy in order to maintain electrical neutrality in lattice, thereby increasing the conductivity.

LaCoO_{3-δ} is one typical perovskite material, which at the normal temperature is rhombohedral structure with the middle thereof forming a distorted octahedral (CoO₆⁹⁻) and at 509 degrees Celsius turns from rhombohedral into a cubic. LaCoO_{3-δ} as the cathode material is a hybrid conductor, with electronic conductivity and ion-conductive properties and functioning as semiconductor. LaCoO_{3-δ} and LaCo_{0.4}Ni_{0.6}O_{3-δ} could be applied to the cathode of the IT-SOFC because of having high electrical conductivity at 500 degrees Celsius, despite their coefficients of thermal expansion and sintering temperatures may be too high.

Thus, if the cathode material used in the IT-SOFC could employ the elements of similar atomic radius to be doped to replace Ni and Co so as to increase the generation of the oxygen vacancy and reduce the coefficient of the thermal expansion and such material could be prepared by solid state synthesis for deriving the optimum parameters for micro-structure and electrical analyses such cathode material may present itself as one desired solution to the previously mentioned deficiency.

### SUMMARY OF THE DISCLOSURE

The present disclosure may provide a ceramic cathode material used in a fuel cell and a preparation method for the same. The ceramic cathode material may be a mix of lanthanum-based compound, cobalt-based compound, and copper-based compound suitable in an intermediate/low temperature fuel cell. And when operating in an intermediate/low temperature environment the disclosed ceramic cathode material may be associated with high electrical conductivity and reduced coefficient of thermal expansion.

Such ceramic cathode material may be represented in LaCo_{y}CuₓO_{3-δ}, the sum of x and y equals to 1, and δ stands for oxygen vacancy value.

Specifically, x may range from 0.01 to 0.3 and y may range from 0.7 to 0.99.

Specifically, the ceramic cathode material is prepared by having a lanthanum-based compound, a cobalt-based compound and a copper-based compound mixed and using a solid state synthesis or a gel synthesis.

Specifically, the lanthanum-based compound comprises lanthanum oxide, lanthanum chloride lanthanum nitrate, lanthanum acetate, lanthanum oxalate or organic metallic salt with lanthanum.

Specifically, the cobalt-based compound comprises cobalt oxide, cobalt chloride, cobalt nitrate, cobalt acetate, cobalt oxalate, or organic metallic salt with cobalt.

Specifically, the copper-based compound comprises copper oxide, copper chloride, copper nitrate, copper acetate, copper oxalate or organic metallic salt with copper.

The disclosed method for preparing such ceramic cathode material may include: pre-heating lanthanum-based compound to remove moisture therein before adding cobalt-based compound and copper-based compound, and subjecting powder of a mix of the lanthanum-based compound, the cobalt-based compound, and the copper-based compound to a first milling, slurry, and drying procedure, preparing a powder body by calcining the powder of the mix of the lanthanum-based compound, the cobalt-based compound, and the copper-based compound before subjecting the powder body to a second milling, slurry, and drying procedure and spindling the dried powder body into a raw embryo, and skimming and sintering the raw embryo to form a cathode bulk before employing the cathode bulk as the ceramic cathode material in the fuel cell in a measurement analysis.

Specifically, the lanthanum-based compound is lanthanum oxide.

Specifically, the cobalt-based compound is cobalt oxide.

Specifically, the copper-based compound is copper oxide.

Specifically, the cathode bulk comprises 70 to 99 atom % of cobalt.

Specifically, the cathode bulk comprises 1-30 atom % of copper.

Specifically, the copper-based compound comprises 5 to 30% of copper in mole percentage.

Another method disclosed for preparing the ceramic cathode material may include dissolving a predetermined amount of lanthanum-based compound, cobalt-based compound, and copper-based compound in a solvent, and preparing a solution with a predetermined ratio of metal ions, adding precipitation into the solution with the predetermined ratio of the metal ions to precipitate the metal ions before subjecting the metal ions to filtering, rinsing, and drying procedure, and subjecting the precipitated metal ions to heat treatment to prepare ceramic cathode powder.

Specifically, the lanthanum-based compound comprises lanthanum chloride, lanthanum nitrate, lanthanum acetate, lanthanum oxalate or organic metallic salt with lanthanum.

Specifically, the cobalt-based compound comprises cobalt chloride, cobalt nitrate, cobalt acetate, cobalt oxalate, or organic metallic salt with cobalt.

Specifically, the copper-based compound comprises copper chloride, copper nitrate, copper acetate, copper oxalate, or organic metallic salt with copper.

Specifically, the ceramic cathode powder comprises 70 to 99 atom % of cobalt.

Specifically, the ceramic cathode powder comprises 1-30 atom % of copper.

Specifically, the copper-based compound comprises 5 to 30% of copper in mole percentage.

For further understanding of the present disclosure, reference is made to the following detailed description illustrating the embodiments and examples of the present disclosure. The description is only for illustrating the present disclosure, not for limiting the scope of the claim.

### BRIEF DESCRIPTION OF THE DRAWINGS

The drawings included herein provide further understanding of the present disclosure. A brief introduction of the drawings is as follows:

FIG. 1 shows a flow chart of a method for preparing a ceramic cathode material used in a fuel cell according to one embodiment of the present disclosure;

FIG. 2 shows analytical curves of coefficients of thermal expansion of ceramic cathode materials according to one embodiment of the present disclosure;

FIG. 3 shows a analytical cures of electrical conductivity of ceramic cathode materials according to one embodiment of the present disclosure;

FIG. 4 shows an analytical table of data of electrical conductivity according to one embodiment of the present disclosure; and

FIG. 5 is another flow chart of a preparation method of the ceramic cathode material according to one embodiment of the present disclosure.

### DESCRIPTION OF THE EXEMPLARY EMBODIMENTS

The aforementioned and other technical contents, features, and efficacies will be shown in the following detail descriptions of a preferred embodiment corresponding with the reference Figures.

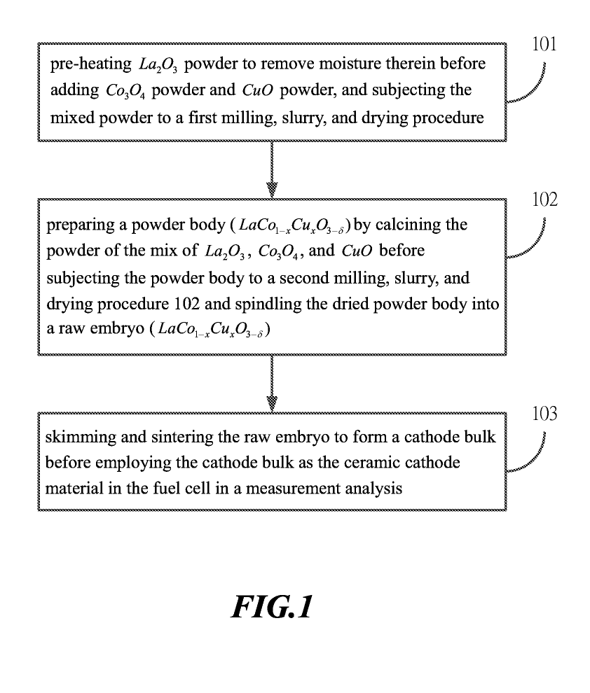

Please refer to FIG. 1 illustrating a flowchart of a preparation method for a ceramic cathode material used in a fuel cell according to one embodiment of the present disclosure. The present disclosure may mix lanthanum-based compound, cobalt-based compound and copper-based compound before prepare the ceramic cathode material using solid-state synthesis. In one implementation, the lanthanum-based compound, which may be lanthanum oxide, is La₂O₃, the cobalt-based compound, which may be cobalt oxide, is Co₃O₄, and the copper-based compound, which may be copper oxide, is CuO. As shown in FIG. 1, the method for preparing the ceramic cathode material or a corresponding cathode bulk may include: (1) in step 101 pre-heating La₂O₃ powder to remove moisture therein before adding Co₃O₄ powder and CuO powder, and subjecting the mixed powder to a first milling, slurry, and drying procedure, (2) in step 102 preparing a powder body (LaCo₁₋ₓCuₓO_{3-δ})by calcining the powder of the mix of La₂O₃, Co₃O₄, and CuO before subjecting the powder body to a second milling, slurry, and drying procedure 102 and spindling the dried powder body into a raw embryo (LaCo₁₋ₓCuₓO_{3-δ}) (wherein the sum of x and y equals to one), and (3) in step 103 skimming and sintering the raw embryo to form a cathode bulk before employing the cathode bulk as the ceramic cathode material in the fuel cell in a measurement analysis.

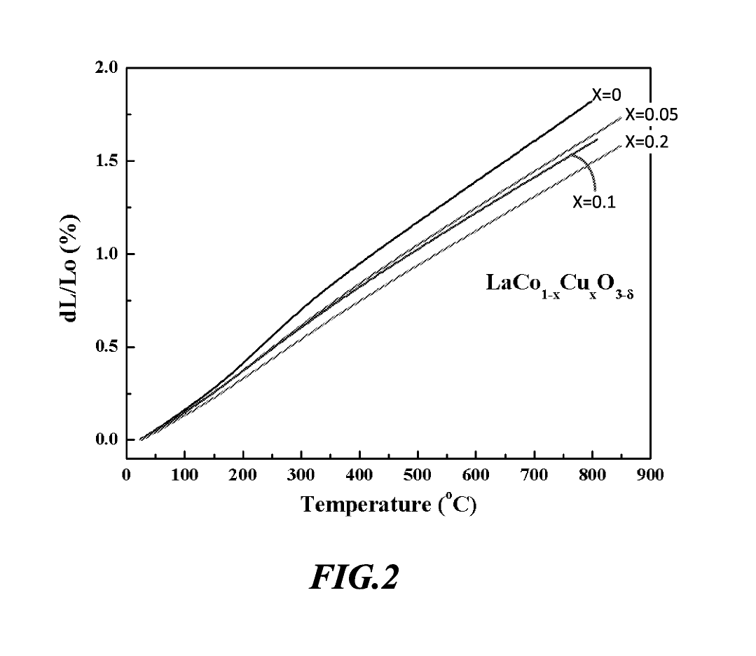

FIG. 2 shows the analysis of coefficient thermal expansion (CTE) of one LaCo₁₋ₓCuₓO_{3-δ} cathode bulk prepared by LaCo O_{3-δ} with CuO doping within the temperature range from 0-900 degrees Celsius. X may range from 0-0.2 standing for copper doping in atomic percentage, while y (or 1-x) stands for cobalt doping in atomic percentage. As shown in FIG. 2, CTE may trend down with x increasing from 0 but being capped at 0.2. Specifically, when LaCo₁₋ₓCuₓO_{3-δ} (and x is equal to 0.2) is used the reduction in CTE may be most significant. For illustrating the advantages of the present disclosure, three cathode bulks are used. The first cathode bulk is LaCoO_{3-δ} without any oxide doping, the second cathode bulk is LaCoO_{3-δ} with NiO doping, and the third cathode bulk is LaCoO_{3-δ} with CuO doping. When operating in 800 degrees Celsius, CTE of the first cathode bulk is 23.9 (10⁻⁶/Celsius), CTE of the second cathode bulk is 18.3 (10⁻⁶/Celsius) and CTE of the third cathode bulk is 19.1 (10⁻⁶/Celsius). Despite the cathode bulk with NiO doping may be associated with the relatively lowest CTE, NiO doping at the same time may not help reduce the sintering temperature nor increase the electrical conductivity. On the other hand, though the cathode bulk with CuO doping may not be associated with the relatively lowest CTE the sintering temperature of such cathode bulk may reduce and the electrical conductivity of the same may increase. As the result, copper doping could be widely utilized according to the present disclosure.

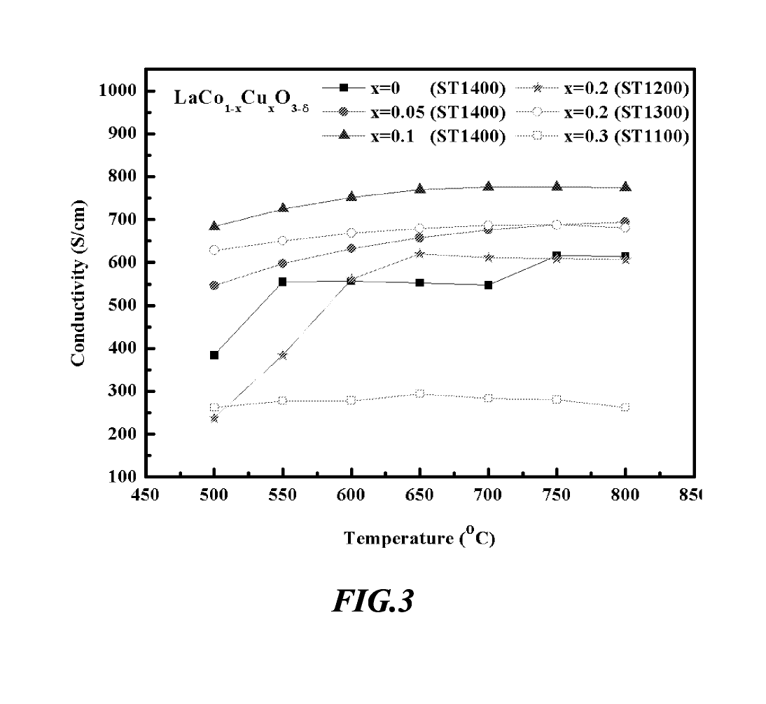

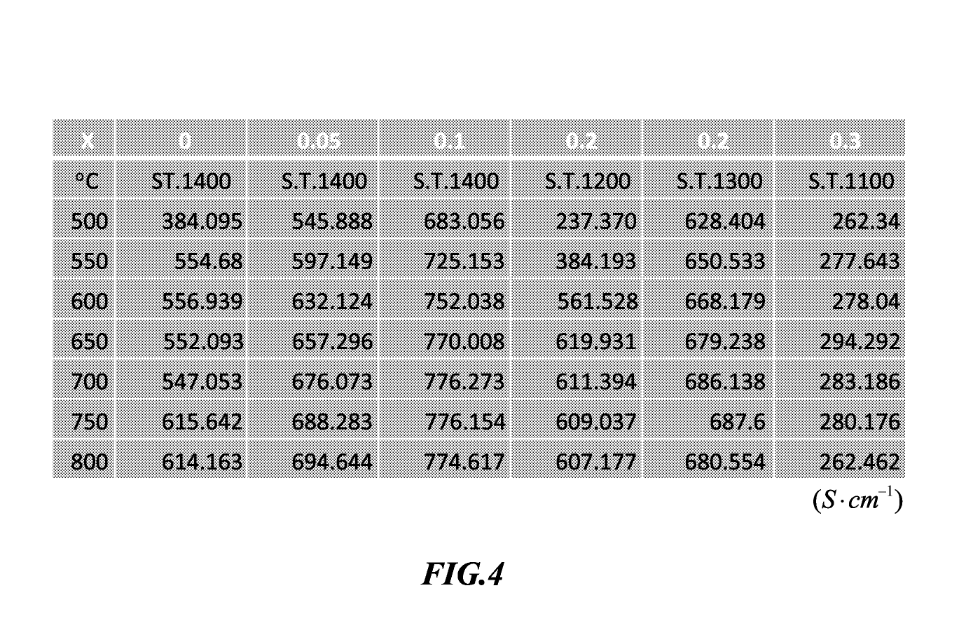

As shown in FIGS. 3 and 4, analytical curves of the electrical conductivity and one analytical table for data of the electrical conductivity with varying x are illustrated. The cathode bulks of LaCo₁₋ₓCuₓO_{3-δ} (i.e., with copper doping) having the sintering temperatures of 1100, 1200, 1300, and 1400 degrees Celsius are measured for their direct current (DC) electrical characteristics within the temperature range from 500-800 degrees

Celsius. As previously mentioned, since the copper doping may increase the electrical conductivity despite such increase may peak when x is equal to 0.2 (in short, the electrical conductivity when x is 0.3 is less than that at the time x is 0.2), the copper doping should be adopted so as to realize the larger electrical conductivity when compared with the traditional ceramic cathode material (e.g., 100 S cm⁻¹).

Though 20 atomic percentage of the copper doping into LaCoO_{3-δ} may help reduce the sintering temperature and increase the electrical conductivity, other atomic percentages of the copper doping may be used as well. For example, x may range from 0.01 to 0.3 including 0.01, 0.0125, 0.025, 0.0375, 0.05, 0.0625, 0.075, 0.0875, 0.1, 0.1125, 0.125, 0.1375, 0.15, 0.1625, 0.175, 0.1875, 0.2, 0.2125, 0.225, 0.2375, 0.25, 0.2625, 0.275, 0.2875, and 0.3 with the atomic percentages of the copper in the cathode bulk ranging from 1 to 30.

Since the sum of x and y equals to one, y may range from 0.7 to 0.99 including 0.7, 0.7125, 0.725, 0.7375, 0.75, 0.7625, 0.775, 0.7875, 0.8, 0.8125, 0.825, 0.8375, 0.85, 0.8625, 0.875, 0.8875, 0.9, 0.9125, 0.925, 0.9375, 0.95, 0.9625, 0.975, 0.9875, and 0.99. Thus, the cobalt in the cathode bulk may account for 70-99 atomic percentages.

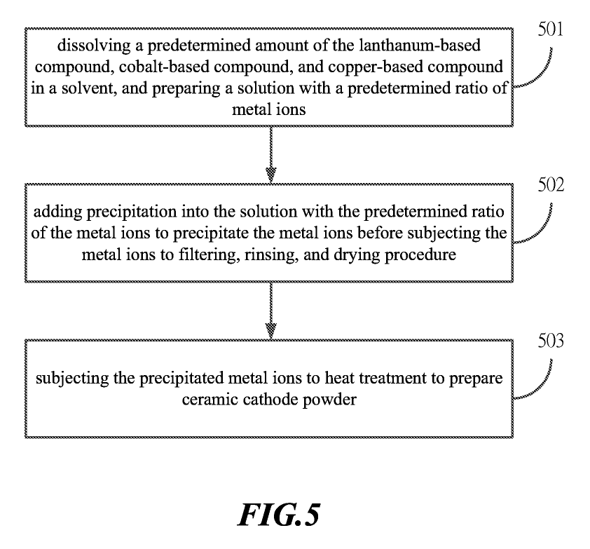

In addition to the oxides described in above, other lanthanum, cobalt, and copper-based compounds may be used. For example, chlorides, nitrates, acetates, oxalates or organic salt classes may be used in the preparation of LaCo₁₋ₓCuₓO_{3-δ} ceramic cathode material. When the chlorides, nitrates, acetates, oxalates or organic salt classes are chosen, gel synthesis may become necessary. As shown in FIG. 5, the corresponding method for preparing such cathode material may include: (1) in step 501 dissolving a predetermined amount of the lanthanum-based compound, cobalt-based compound, and copper-based compound in a solvent, and preparing a solution with a predetermined ratio of metal ions, (2) in step 502 adding precipitation into the solution with the predetermined ratio of the metal ions to precipitate the metal ions before subjecting the metal ions to filtering, rinsing, and drying procedure, and (3) in step 503 subjecting the precipitated metal ions to heat treatment to prepare ceramic cathode powder.

In comparison with the traditional arts, the present disclosure may be with advantages of: (1) higher electrical conductivity and reduced CTE when LaCo₁₋ₓCuₓO_{3-δ} cathode bulk is prepared with the lanthanum, cobalt, copper-based compounds through either solid-sate or gel synthesis and used in middle/low temperature environments (500-800 degrees Celsius), and (2) increased electrical conductivity and reduced sintering temperature and CTE when LaCo₁₋ₓCuₓO_{3-δ} cathode bulk is doped with increased amount of copper.

Some modifications of these examples, as well as other possibilities will, on reading or having read this description, or having comprehended these examples, will occur to those skilled in the art. Such modifications and variations are comprehended within this disclosure as described here and claimed below. The description above illustrates only a relative few specific embodiments and examples of the present disclosure. The present disclosure, indeed, does include various modifications and variations made to the structures and operations described herein, which still fall within the scope of the present disclosure as defined in the following claims.

What is claimed is:

1. A ceramic cathode material used in a fuel cell, wherein the ceramic cathode material is represented in LaCo_{y}CuₓO_{3-δ}, the sum of x and y equals to 1, and δ stands for oxygen vacancy value.

2. The ceramic cathode material according to claim 1, wherein x ranges from 0.01 to 0.3 and y ranges from 0.7 to 0.99.

3. The ceramic cathode material according to claim 1, wherein the ceramic cathode material is prepared by having a lanthanum-based compound, a cobalt-based compound and a copper-based compound mixed and using a solid state synthesis or a gel synthesis.

4. The ceramic cathode material according to claim 3, wherein the lanthanum-based compound comprises lanthanum oxide, lanthanum chloride lanthanum nitrate, lanthanum acetate, lanthanum oxalate or organic metallic salt with lanthanum.

5. The ceramic cathode material according to claim 3, wherein the cobalt-based compound comprises cobalt oxide, cobalt chloride, cobalt nitrate, cobalt acetate, cobalt oxalate, or organic metallic salt with cobalt.

6. The ceramic cathode material according to claim 3, wherein the copper-based compound comprises copper oxide, copper chloride, copper nitrate, copper acetate, copper oxalate or organic metallic salt with copper.

7. A method for preparing a ceramic cathode material used in a fuel cell, comprising:
pre-heating lanthanum-based compound to remove moisture therein before adding cobalt-based compound and copper-based compound, and subjecting powder of a mix of the lanthanum-based compound, the cobalt-based compound, and the copper-based compound to a first milling, slurry, and drying procedure;
preparing a powder body by calcining the powder of the mix of the lanthanum-based compound, the cobalt-based compound, and the copper-based compound before subjecting the powder body to a second milling, slurry, and drying procedure and spindling the dried powder body into a raw embryo; and
skimming and sintering the raw embryo to form a cathode bulk before employing the cathode bulk as the ceramic cathode material in the fuel cell in a measurement analysis.

8. The method according to claim 7, wherein the lanthanum-based compound is lanthanum oxide.

9. The method according to claim 7, wherein the cobalt-based compound is cobalt oxide.

10. The method according to claim 7, wherein the copper-based compound is copper oxide.

11. The method according to claim 7, wherein the cathode bulk comprises 70 to 99 atom % of cobalt.

12. The method according to claim 7, wherein the cathode bulk comprises 1-30 atom % of copper.

13. The method according to claim 7, wherein the copper-based compound comprises 5 to 30% of copper in mole percentage.

14. A method for preparing a ceramic cathode material used in a fuel cell, comprising:
dissolving a predetermined amount of lanthanum-based compound, cobalt-based compound, and copper-based compound in a solvent, and preparing a solution with a predetermined ratio of metal ions;
adding precipitation into the solution with the predetermined ratio of the metal ions to precipitate the metal ions before subjecting the metal ions to filtering, rinsing, and drying procedure; and
subjecting the precipitated metal ions to heat treatment to prepare ceramic cathode powder.

15. The method according to claim 14, wherein the lanthanum-based compound comprises lanthanum chloride, lanthanum nitrate, lanthanum acetate, lanthanum oxalate or organic metallic salt with lanthanum.

16. The method according to claim 14, wherein the cobalt-based compound comprises cobalt chloride, cobalt nitrate, cobalt acetate, cobalt oxalate, or organic metallic salt with cobalt.

17. The method according to claim 14, wherein the copper-based compound comprises copper chloride, copper nitrate, copper acetate, copper oxalate, or organic metallic salt with copper.

18. The method according to claim 14, wherein the ceramic cathode powder comprises 70 to 99 atom % of cobalt.

19. The method according to claim 14, wherein the ceramic cathode powder comprises 1-30 atom % of copper.

20. The method according to claim 14, wherein the copper-based compound comprises 5 to 30% of copper in mole percentage.
